(19) United States
(12) Patent Application Publication
(10) Pub. No.: US 2009/0322172 A1
(43) Pub. Date: Dec. 31, 2009

(54) HYBRID THREE-POLE ACTIVE MAGNETIC BEARING AND METHOD FOR EMBODYING LINEAR MODEL THEREOF

(75) Inventors: Chong-Won LEE, Daejeon (KR); Sang-Hyun PARK, Daejeon (KR)

Correspondence Address: GLOBAL IP COUNSELORS, LLP, 1233 20TH STREET, NW, SUITE 700, WASHINGTON, DC, 20036-2680, US

(73) Assignee: KOREA ADVANCED INSTITUTE OF SCIENCE AND TECHNOLOGY, Daejeon (KR)

(21) Appl. No.: 12/490,004

(22) Filed: Jun. 23, 2009

(30) Foreign Application Priority Data
Jun. 27, 2008 (KR) 10-2008-0061319

(51) Int. Cl. H02K 7/09

(52) U.S. Cl. 310/90.5

(57) ABSTRACT

Disclosed are a hybrid three-pole active magnetic bearing and a method for embodying a linear model thereof. The hybrid three-pole active magnetic bearing comprises: a stator including a main-magnetic pole in which three magnetic poles are arranged in a fan-shape at an interval of 120 degrees and the three magnetic poles are wound by a coil respectively and a sub-magnetic pole in which three magnetic poles are arranged in a fan-shape at an interval of 120 degrees and a permanent magnet is provided at peripheral ends of the three magnetic poles respectively; and a rotor enclosing a circumference of the stator, in which the three magnetic poles of the main-magnetic pole and the three magnetic poles of the sub-magnetic pole are alternately located at the same interval, and the sub-magnetic pole further includes a pole shoe is formed as a “U” shape and provided at a peripheral end of the permanent magnet.

### BACKGROUND OF THE INVENTION

1. Field of the Invention

The present invention relates to a hybrid three-pole active magnetic bearing and a method for embodying a linear model thereof, more particularly to a technique for measuring displacement of a hybrid three-pole active magnetic bearing.

2. Description of the Related Art

Active magnetic bearings, unlike existing rolling bearings or sliding bearings supporting a shaft through a physical contact, are non-contact type bearings that support a shaft through magnetic force.

Recently, as the application scope of the bearing has been expanded from a large system such as high speed spindles or vacuum pumps to a small system such as hard disks, artificial hearts or turbo coolers, miniaturization of the active magnetic bearings become an important factor.

In accordance with the demands, three-pole active magnetic bearings beneficial in terms of miniaturization and capable of reducing a loss of electric power have been proposed.

FIG. 1 is a drawing illustrating magnetic flux distribution of a general three-pole active magnetic bearing. FIG. 1 shows radial cross-section of a three-pole magnetic bearing. As shown in FIG. 1, since the three-pole active magnetic bearing is non-linear due to its shape, it is difficult to embody a linear model using general rectangular coordinates system. For this reason, there is a demand for complex non-linear control scheme.

Active magnetic bearings are generally classified into either heteropolar active magnetic bearing or homopolar active magnetic bearing according to an arranged shape of a pole generating a force.

FIG. 2A is a drawing illustrating a heteropolar active magnetic bearing. FIG. 2B is a drawing illustrating a homopolar active magnetic bearing.

As shown in FIG. 2A, in the heteropolar magnetic bearing, electromagnets are arranged to have different poles respectively and magnetic fluxes of the electromagnets are generated in the radial direction.

Meanwhile, as shown in FIG. 2B, in the homopolar active magnetic bearing, electromagnets are arranged to have the same polarity and magnetic fluxes of the electromagnets flow along their axes.

FIG. 3 is a cross-sectional drawing illustrating a structure of a conventional rotary disc type active magnetic bearing.

As shown in FIG. 3, the rotary disc type active magnetic bearing is composed of a radial active magnetic bearing 12 and a thrust active magnetic bearing 13 for levitation of 5 freedom degrees. Further, the rotary disc type active magnetic bearing includes a radial non-contact displacement sensor 14 and a thrust non-contact displacement sensor 15. However, the rotary disc type active magnetic bearing has a disadvantage that an entire size of a rotary disc type active magnetic bearing is increased for the radial non-contact displacement sensor 14 and a mount (not shown) thereof. Moreover, a cost rate of two radial non-contact displacement sensors 14 which are installed respectively in x axis and y axis direction and one thrust non-contact displacement sensor 15 are an obstacle to commercialize not only the rotary disc type active magnetic bearing but also a general active magnetic bearing.

To resolve this problem, various displacement measuring technologies have been proposed. A method using a Hall sensor is one of the various displacement measuring technologies. However, since the conventional active magnetic bearing using a Hall sensor has low sensitivity due to a saturation problem of a magnetic flux, the conventional active magnetic bearing using a Hall sensor is not suitable to be used as a position sensor.

### SUMMARY OF THE INVENTION

The present invention has been made in view of the above problems, and it is an object of the present invention to reduce a Hall sensor's cost of an active magnetic bearing's total costs and to miniaturize the active magnetic bearing by designing the stator so that the Hall sensor mounted in the stator can be used with high sensitivity.

It is another object of the present invention to provide a hybrid three-pole active magnetic bearing in which a silicon steel plate is stacked on a stator and a rotor in order to minimize a loss of electric power due to eddy current effect during rotation of the active magnetic bearing.

It is another object of the present invention to provide a PD (proportional-derivative) controller on each of coordinate axes using a redundant coordinates system suitable to a three-pole shape.

A hybrid three-pole active magnetic bearing related to claim 1 comprises: a stator including a main-magnetic pole in which three magnetic poles are arranged in a fan-shape at an interval of 120 degrees and the three magnetic poles are wound by coils respectively and a sub-magnetic pole in which three magnetic poles are arranged in a fan-shape at an interval of 120 degrees and which is provided with a permanent magnet at peripheral ends of the three magnetic poles respectively; and a rotor enclosing a circumference of the stator, wherein the three magnetic poles of the main-magnetic pole and the three magnetic poles of the sub-magnetic pole are alternately located at the same interval, and the sub-magnetic pole further includes a pole shoe formed as a “U” shape and provided at a peripheral end of the permanent magnet.

The hybrid three-pole active magnetic bearing related to claim 1 comprises a stator and a rotor. The stator includes a main-magnetic pole in which three magnetic poles are arranged in a fan-shape at an interval of 120 degrees and the three magnetic poles are wound by a coil respectively and a sub-magnetic pole in which three magnetic poles are arranged in a fan-shape at an interval of 120 degrees and which is provided with a permanent magnet at peripheral ends of the three magnetic poles respectively. The sub-magnetic pole includes a permanent magnet and a pole shoe. Here, the permanent magnet provides constant magnetic flux to an active magnetic bearing. Also, the sub-magnetic pole is provided with the pole shoe at a peripheral end of the permanent magnet. The pole shoe is formed as a “U” shape.

Consequently, according to the hybrid three-pole active magnetic bearing related to claim 1, since a peripheral end of the permanent magnet is formed as a “U” shape, a Hall sensor with high resolution can be used.

A hybrid three-pole active magnetic bearing related to claim 2 is the hybrid three-pole active magnetic bearing according to claim 1, wherein a displacement sensor is provided in a groove of the “U” shaped pole shoe.

The hybrid three-pole active magnetic bearing related to claim 2 senses a position of the rotor by installing a displacement sensor at an end of the sub-magnetic pole, namely a groove of the “U” shaped pole shoe.

Consequently, according to the hybrid three-pole active magnetic bearing related to claim 2, since the sub-magnetic pole is not influenced by a control magnetic flux but influenced by only the position of the rotor by installing a displacement sensor in a “U” shaped groove of the pole shoe, displacement sensing can be sensitively achieved.

A hybrid three-pole active magnetic bearing related to claim 3 is the hybrid three-pole active magnetic bearing according to claim 2, wherein the displacement sensor is a Hall sensor with high resolution.

Since the hybrid three-pole active magnetic bearing related to claim 3 forms a groove in the “U” shaped pole shoe, only very small amount of a magnetic flux flows to the Hall sensor as a target.

Consequently, in the hybrid three-pole active magnetic bearing related to claim 3, since a small amount of a magnetic flux flows through a sub-magnetic pole, a Hall sensor with high resolution can be used, so high sensitivity can be obtained.

A hybrid three-pole active magnetic bearing related to claim 4 is the hybrid three-pole active magnetic bearing according to claim 1, wherein a silicon steel plate of a thickness of about 0.1 mm is stacked on the stator and the rotor.

The hybrid three-pole active magnetic bearing related to claim 4 minimizes a loss of electric power due to eddy current effects during rotation of the magnetic bearing by stacking a silicon steel plate of a thickness of about 0.1 mm on the stator and the rotor.

Consequently, since the hybrid three-pole active magnetic bearing related to claim 4 stacks a silicon steel plate on a stator and a rotor, it can minimize a loss of electric power due to eddy current effect during rotation of the active magnetic bearing.

A method for embodying a linear model of a hybrid three-pole active magnetic bearing related to claim 5 embodies the linear model by introducing a redundant coordinates system (q₁, q₂, q₃) formed at the same interval of 120 degrees, and by using a PD controller provided independently on each of three axes of the redundant coordinates system.

The method for embodying a linear model of a hybrid three-pole active magnetic bearing related to claim 5 introduces a redundant coordinates system (q₁, q₂, q₃) suited to shapes of three magnetic poles so as to embody the linear model of the hybrid three-pole active magnetic bearing. The linear model is embodied by providing the PD controller independently on each of coordinate axes of the redundant coordinates system.

Consequently, the method for embodying a linear model of a hybrid three-pole active magnetic bearing related to claim 5 can embody a linear model of a three-pole magnetic bearing with a non-linearity due to its shape by introducing a redundant coordinates system (q₁, q₂, q₃) suited to shapes of three magnetic poles, and by providing a PD controller on each of coordinate axes of the redundant coordinates system so as to linearize the model of the three-pole active magnetic bearing.

A method for embodying a linear model of a hybrid three-pole active magnetic bearing related to claim 6 is method according to claim 5, wherein a PD controller diagonalizes an electromagnetic force matrix for a motion equation of the hybrid three-pole active magnetic bearing.

In the method for embodying a linear model of a hybrid three-pole active magnetic bearing related to claim 6, since a PD controller diagonalizes an electromagnetic force matrix including a cross-coupled term in a motion equation induced in case of modeling the hybrid three-pole active magnetic bearing, the electromagnetic force matrix is cross-uncoupled.

Consequently, since the method for embodying a linear model of a hybrid three-pole active magnetic bearing related to claim 6 diagonalizes an electromagnetic force matrix in a motion equation of the hybrid three-pole active magnetic bearing, the selection number of a gain can be reduced by using the symmetry and all of three signals received from a sensor can be used.

In the present invention having a structure as described above, the selection number of again can be reduced using symmetry, and all of three signals received from a sensor can be used.

Moreover, in the present invention, a Hall sensor's cost of an active magnetic bearing's total costs can be reduced by using a Hall sensor in place of a non-contact displacement sensor for the active magnetic bearing.

Furthermore, since the present invention is used as a built-in type system without a separate sensor mount, it is beneficial to miniaturize an active magnetic bearing.

In addition, in the present invention, a loss of electric power due to an eddy current during rotation of the active magnetic bearing can be minimized by stacking a silicon steel plate of a thickness of about 0.1 mm on a stator and a rotor of the active magnetic bearing.

Also, in the present invention, an simple PD controller is independently provided on each of axes by introducing a redundant coordinates system arranged at the same interval of 120 degrees in a hybrid three-pole active magnetic bearing using a permanent magnet. Accordingly, a motion equation of an active magnetic bearing can be simply induced. Further, since a cross-coupled term is removed, an independent motion equation can be used.

The objects, constructions and effects of the present invention are included in the following embodiments and drawings. The advantages, features, and achieving methods of the present invention will be more apparent from the following detailed description in conjunction with embodiments and the accompanying drawings. The same reference numerals are used throughout the drawings to refer to the same or like parts.

### BRIEF DESCRIPTION OF THE DRAWINGS

The objects, features and advantages of the present invention will be more apparent from the following detailed description in conjunction with the accompanying drawings, in which:

FIG. 1 is a drawing illustrating magnetic flux distribution of a general three-pole active magnetic bearing;

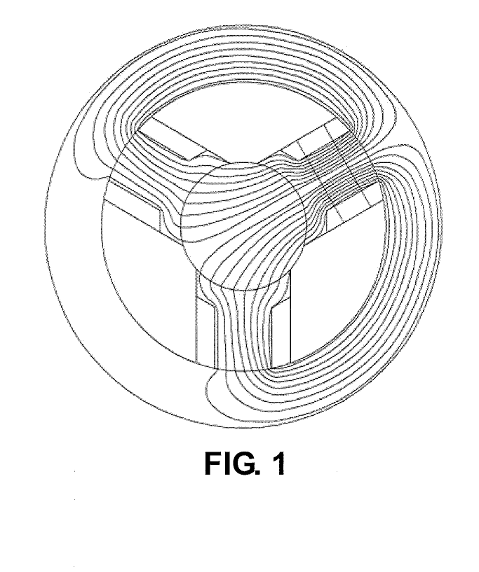

FIG. 2A is a drawing illustrating a heteropolar active magnetic bearing;

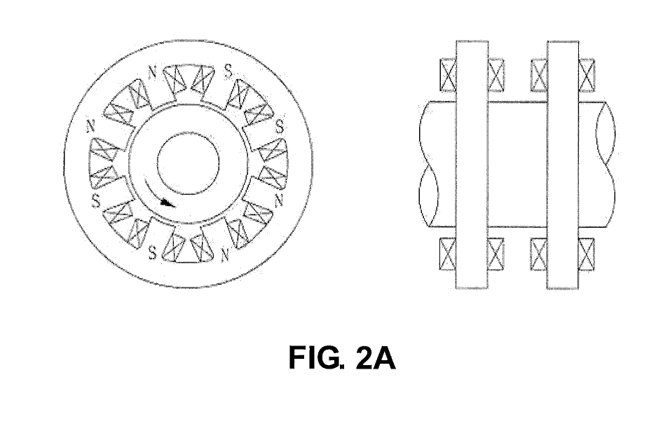

FIG. 2B is a drawing illustrating a homopolar active magnetic bearing;

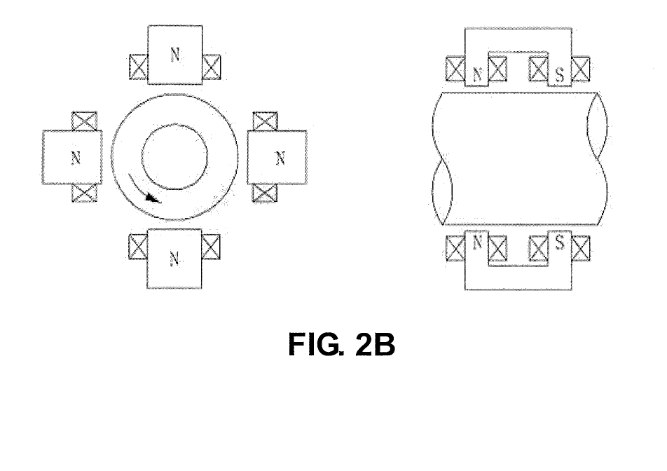

FIG. 3 is a cross-sectional drawing illustrating a structure of a conventional rotary disc type active magnetic bearing;

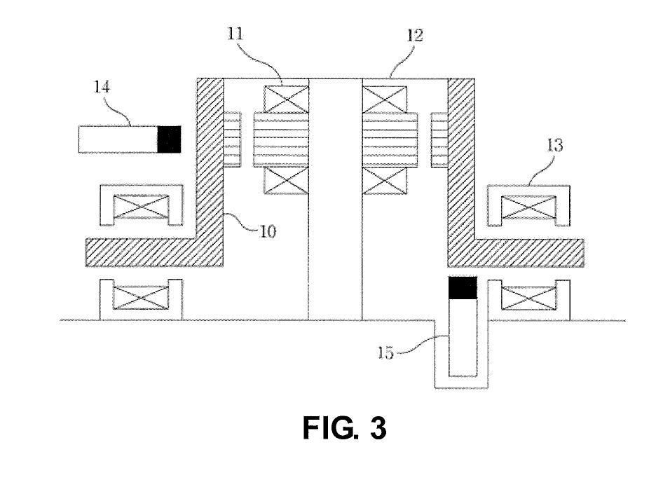

FIG. 4 is a drawing illustrating a structure of an active magnetic bearing according to an embodiment of the present invention;

FIG. 5 is a drawing illustrating a structure of a radial magnetic bearing system according to an embodiment of the present invention;

FIG. 6 is a drawing illustrating a flow of a bias magnetic flux formed in a pole shoe by a permanent according to an embodiment of the present invention;

FIG. 7 is a drawing illustrating a redundant coordinates system and a rectangular coordinates system for embodying a linear model of a three-pole magnetic bearing used in a method for embodying a linear model of a hybrid three-pole active magnetic bearing; and

FIG. 8 is a drawing illustrating a redundant coordinates system of a radial active magnetic bearing used in a method for embodying a linear model of a hybrid three-pole active magnetic bearing.

### DETAILED DESCRIPTION OF EXEMPLARY EMBODIMENTS

Hereinafter, exemplary embodiments of the present invention will be described in detail with reference to the accompanying drawings. However, the accompanying drawings are included for explaining the present invention but are not intended to be limited to the embodiments shown, so that those skilled in the art may easily use the present invention.

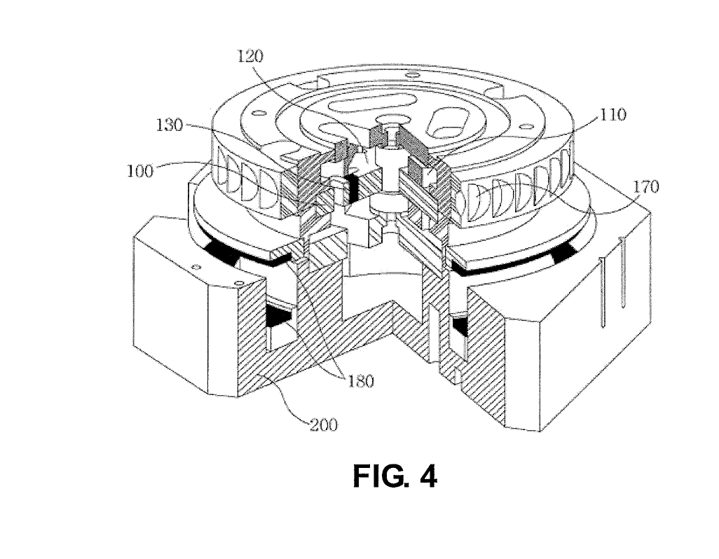

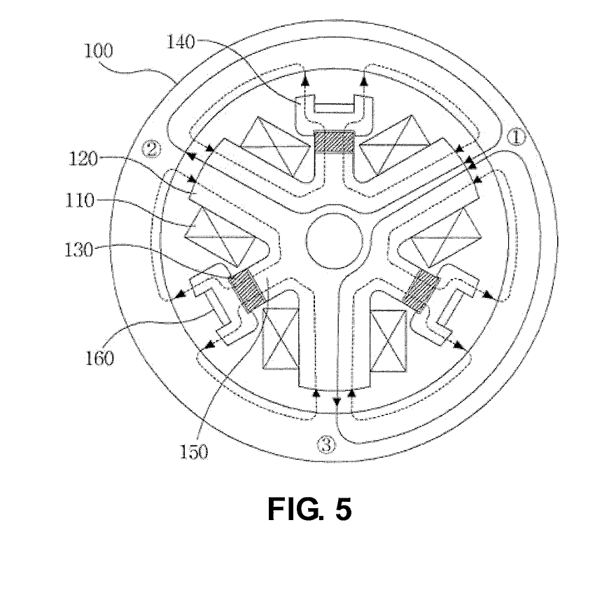

FIG. 4 is a drawing illustrating a structure of an active magnetic bearing according to an embodiment of the present invention. FIG. 5 is a drawing illustrating a structure of a radial active magnetic bearing according to an embodiment of the present invention.

As shown in FIG. 4 and FIG. 5, the active magnetic bearing according to the present invention includes a stator (not shown) and a rotor 100.

The rotor 100 encloses a circumference of the stator.

The stator includes a main-magnetic pole 120 and a sub-magnetic pole 150. In the main-magnetic pole 120, three magnetic poles are arranged in a fan-shape at an interval of 120 degrees, and the three magnetic poles are wound by a coil respectively. In the sub-magnetic pole 150, three magnetic poles are arranged in a fan-shape at an interval of 120 degrees, and a permanent magnet is provided at peripheral end of each of the three magnetic poles.

The three magnetic poles of the main-magnetic pole 120 and the three magnetic poles of the sub-magnetic pole 150 are alternately located at the same interval.

The sub-magnetic pole 150 includes the permanent magnet 130, a pole shoe 140, and a Hall sensor 160. The permanent magnet 130 applies a constant magnetic flux to the active magnetic bearing. The pole shoe 140 is formed as a “U” shape and provided at a peripheral end of the permanent magnet 130.

The main-magnetic pole 120 is comprised of silicon steel plates stacked. The three magnetic poles of the main-magnetic pole 120 are wound by a coil respectively. The three magnetic poles of the main-magnetic pole 120 and the three magnetic poles of the sub-magnetic pole 150 are alternately located at the same interval of 60 degrees.

A silicon steel plate of a thickness of about 0.1 mm is stacked on a stator and a rotor 100 in order to minimize a loss of electric power due to eddy current effect during rotation of the active magnetic bearing.

Further, the Hall sensor 160 is a position sensor of the active magnetic bearing, and is mounted in a “U” shaped-groove of the pole shoe 140.

However, in order to use the Hall sensor 160, following two considerations should be made at the design. The first consideration is a resolution of the Hall sensor. Although a linear Hall effective sensor outputting a voltage corresponding to an intensity of an external magnetic field is used as the Hall sensor, most of commonly used Hall sensors have very low resolution for a position sensor. The second consideration is a mounting position of a Hall sensor. In order to use the Hall sensor as the position sensor, the Hall sensor should be mounted on a position where the magnetic flux is not changed by a control magnetic flux and is sensitively changed by only a position of the rotor.

Accordingly, the Hall sensor 160 is located in the sub-magnetic pole 150 in which the permanent magnet 130 is located. That is why the sub-magnetic pole 150 is not influenced by the control magnetic flux and is influenced by only a position of the rotor because of large magnetic resistance of the permanent magnet 130. However, the sub-magnetic pole 150 has a large magnetic flux density that the Hall sensor 160 of high resolution cannot measure. Consequently, in the present invention, a peripheral end of the permanent magnet 130 of the sub-magnetic pole 150 is formed as a “U” shape so that the Hall sensor of high resolution can be used. In this case, the “U” shape functions as the pole shoe 140. Most bias magnetic flux flows from a peripheral end of the permanent magnet 130 to both ends of the pole shoe 140. Only very small amount of a magnetic flux flows to the Hall sensor as a target. As a result, the Hall sensor of high resolution can be used.

Meanwhile, a dotted line of FIG. 5 indicates a constant magnetic flux supplied to an inside of the active magnetic bearing by the permanent magnet 130, which is located in each sub-magnetic pole 150. In this case, the constant magnetic flux is called bias magnetic flux.

In this case, a bias current should be continuously supplied to the active magnetic bearing composed of only electromagnets without permanent magnets so as to endow the active magnetic bearing with a bias magnetic flux. In detail, the bias magnetic flux is generated by the permanent magnet 130, and flows to a neighboring main-magnetic pole 120 through the pole shoe 140, a pore and the rotor 100.

Meanwhile, a solid line of FIG. 5 indicates a control magnetic flux generated upon applying a control current to the main-magnetic pole \textcircled{1}. In this case, the control magnetic flux does not flow to the sub-magnetic pole 150 unlike the bias magnetic flux. When the magnetic flux is considered as an electric current in a current and resistance circuit, the permanent magnet 130 in which located in the sub-magnetic pole 150 can be considered as a great electric resistance. Accordingly, the control magnetic flux hardly flows to the sub-magnetic pole 150 but flows to only main-magnetic poles 120 located at both sides of the sub-magnetic pole 150. Namely, the sub-magnetic pole 150 is hardly influenced by the control magnetic flux but is influenced by only pores, which are changed according to the position change of the rotor 100. For this reason, it will be appreciated that the Hall sensor 160 is preferably located in the sub-magnetic pole 150. Further, the control magnetic flux causes a magnetic flux unbalance of each main-magnetic pole. That is, in the main-magnetic pole \textcircled{1} to which the control current is supplied, since the bias magnetic flux and the control magnetic flux are applied to the main-magnetic pole \textcircled{1}, the magnetic flux density is increased. In remaining main-magnetic poles \textcircled{2} and \textcircled{3}, since the control magnetic flux is subtracted from the bias magnetic flux, the magnetic flux density is reduced. As a result, the rotor is forced in a direction which the main-magnetic pole \textcircled{1} draws the rotor. Accordingly, the rotor does not collide against the stator and is floated to be located at the center. After this manner, since the control current is applied to the main-magnetic pole and the rotor is forced in any directions (that is, directions of ±□, ±□, ±□ of FIG. 5), unstable active magnetic bearing can be floated.

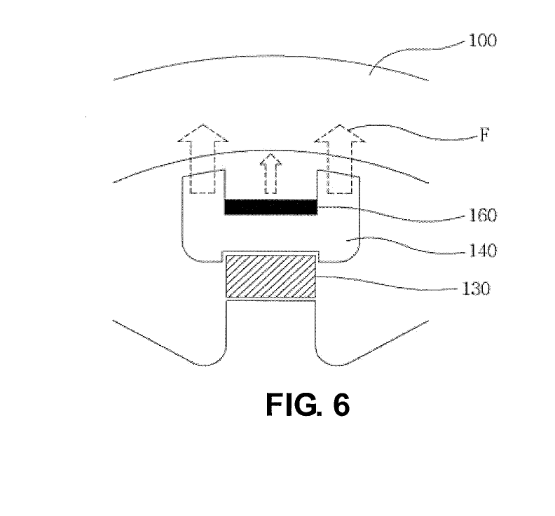

FIG. 6 is a drawing illustrating a flow of a bias magnetic flux formed in a pole shoe by a permanent magnet according to an embodiment of the present invention.

As shown in FIG. 6, a pole shoe 140 according to the present invention is formed as a “U” shape at a peripheral end of the permanent magnet 130. Because the pole shoe 140 is formed as the “U” shape, most bias magnetic flux flows from the permanent magnet 130 to both ends F of the pole shoe 140. Consequently, only a very small amount of the magnetic flux flows to the Hall sensor as a target.

Accordingly, since the active magnetic bearing according to the present invention can use the Hall sensor 160 with high resolution, a high sensitivity can be obtained.

The present invention relates to a hybrid three-pole magnetic bearing using a permanent magnet, which uses a heteropolar type suitable for a rotary disk type. A heteropolar active magnetic bearing is advantageous that an axial direction is shorter than that of a homopolar magnetic bearing. Moreover, since a rotor is installed outside a stator, the heteropolar active magnetic bearing is designed to be suitable for miniaturization.

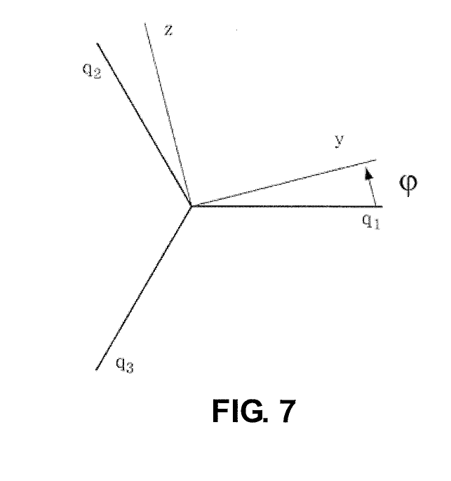

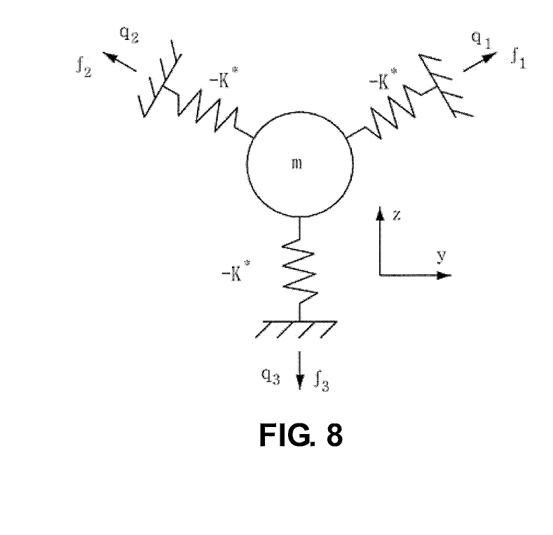

Hereinafter, a method for embodying a linear model of the hybrid three-pole active magnetic bearing described above is illustrated referring to FIG. 7 and FIG. 8.

FIG. 7 is a drawing illustrating a redundant coordinates system and a rectangular coordinates system for embodying a linear model of a three-pole active magnetic bearing used in a method for embodying a linear model of the hybrid three-pole active magnetic bearing.

In the active magnetic bearing according to the present invention, three main-magnetic poles and three sub-magnetic poles are arranged at intervals of 120 degrees respectively. Such a three-pole pattern has a difficulty in constructing a linearization model using a general rectangular coordinates system because of non-linearity due to its shape. Concretely, upon linearizing the electromagnetic force with respect to a position and a control current using the rectangular coordinates system, a cross-coupled term incapable of being expressed as a primary linearization coefficient occurs. Because across-coupled term in capable of being expressed as a primary linearization coefficient occurs, linearization is impossible using the rectangular coordinates system. Accordingly, in the most of three-pole active magnetic bearings, non-linearization control is widely used.

With respect to this, since the present invention configures an simple PD controller independently on each of axes using the redundant coordinates system arranged at the same interval of 120 degrees in the hybrid three-pole active magnetic bearing using the permanent magnet, cross-uncoupling control for an active magnetic bearing system can be performed.

The present invention uses the redundant coordinates system (q₁, q₂, q₃) which is arranged at the same interval of 120 degrees like a shape of the active magnetic bearing for embodying a linear model. Here, the redundant coordinates system should satisfy one constraint equation, which is expressed by the following equation (1).

g:q₁+q₂+q₃=0 (1)

Further, prior to modeling the active magnetic bearing using the redundant coordinates system, there is a need for a transformation matrix between a physical coordinates system (y,z) and the redundant coordinates system (q₁, q₂, q₃).

Referring to FIG. 7, the following is a description of the relation between two coordinates systems (redundant coordinates system and rectangular coordinates system).

First, the following equation (2) is a transformation matrix, Tₛ. Moreover, in the active magnetic bearing according to the present invention, Φ is equal to −30°. When formularizing a motion equation of the active magnetic bearing, the motion equation expressed by the physical coordinates system (y,z) can be expressed by the redundant coordinates system (q₁, q₂, q₃) using the transformation matrix of the equation (2).

$${q}_{yz 0} = {T}_{s} {q}_{123} , where {q}_{yz 0}^{T} = {[ yz 0 ]}^{T} , {q}_{123}^{T} = {[ {q}_{1} {q}_{2} {q}_{3} ]}^{T} \\ {T}_{s} = \frac{2}{3} ( \begin{matrix}cos ϕ & cos ( ϕ - \frac{2 π}{3} ) & cos ( ϕ + \frac{2 π}{3} ) \\ - sin ϕ & - sin ( ϕ - \frac{2 π}{3} ) & - sin ( ϕ + \frac{2 π}{3} ) \\ \frac{1}{2} & \frac{1}{2} & \frac{1}{2}\end{matrix} ) \qquad ( 2 )$$

where, a variable 0 is an imitation variable adjusting simply the coordinate number of two coordinates system.

FIG. 8 is a drawing illustrating a redundant coordinates system of a radial active magnetic bearing used in a method for embodying a linear model of a hybrid three-pole active magnetic bearing.

Referring to FIG. 8, modelization of the active magnetic bearing is described. Firstly, K′ and fᵢ indicate a position stiffness of the active magnetic bearing and an electromagnetic force in each direction. Hereinafter, a motion equation is expressed by using a Lagrange equation and a redundant coordinates system. However, because the active magnetic bearing of 2 freedom degrees is modeled using three redundant coordinates systems, it is evident that there is one holonomic constraint. The holonomic constraint is expressed by the equation (1). It will be appreciated that there is a need for the Lagrange equation with the holonomic constraints through the equation (1). A following equation (3) is the Lagrange equation with the holonomic constraints.

$$\frac{d}{d t} ( \frac{\partial L}{\partial {q}_{k}} ) - \frac{\partial L}{\partial {q}_{k}} = {\sum }_{l = 1}^{m} {λ}_{l} {a}_{lk} , \\ where k = 1 , 2 , 3 \\ m = 1 \\ {a}_{lk} = \frac{\partial {g}_{k}}{\partial {q}_{k}} \qquad ( 3 )$$

where, L is a Lagrangian, and λᵢ is a Lagrange multiplier. The Lagrange multiplier is a force satisfying physically the constraints (equation (1)). The Lagrangian L considering the equation (1) is expressed by the following equation (4).

$$\begin{matrix}\begin{matrix}L = T - V \\ = \frac{1}{2} m ( {y}^{2} + {z}^{2} ) - \frac{1}{2} ( - {K}^{*} ) ( {q}_{1}^{2} + {q}_{2}^{2} + {q}_{3}^{2} ) \\ = \frac{2}{9} m \{ {q}_{1}^{2} + {q}_{2}^{2} + {q}_{3}^{2} - {q}_{1} {q}_{2} - {q}_{2} {q}_{3} - {q}_{3} {q}_{1} \} - \\ \frac{1}{2} ( - {K}^{*} ) ( {q}_{1}^{2} + {q}_{2}^{2} + {q}_{3}^{2} )\end{matrix} & ( 4 )\end{matrix}$$

By using the equations (1) and (4), the equation (3) can be expressed by a following equation (5) with respect to each axis of the redundant coordinates system.

$$\frac{2}{9} m ( \begin{matrix}2 & - 1 & - 1 \\ - 1 & 2 & - 1 \\ - 1 & - 1 & 2\end{matrix} ) \{ \begin{matrix}{q}_{1} \\ {q}_{2} \\ {q}_{3}\end{matrix} \} - {K}^{′} ( \begin{matrix}1 & 0 & 0 \\ 0 & 1 & 0 \\ 0 & 0 & 1\end{matrix} ) \{ \begin{matrix}{q}_{1} \\ {q}_{2} \\ {q}_{3}\end{matrix} \} = \{ \begin{matrix}{f}_{1} + λ \\ {f}_{2} + λ \\ {f}_{3} + λ\end{matrix} \} \qquad ( 5 )$$

Further, in the equation (5), it will be appreciated that the λ is a sum of electromagnetic forces of each axis. λ is expressed by a following equation (6).

$$λ = - \frac{1}{3} \{ {f}_{1} + {f}_{2} + {f}_{3} \} \qquad ( 6 )$$

A following equation (7) is obtained by inputting the λ induced in the equation (6).

$$\frac{2}{3} m ( \begin{matrix}1 & 0 & 0 \\ 0 & 1 & 0 \\ 0 & 0 & 1\end{matrix} ) \{ \begin{matrix}{q}_{1} \\ {q}_{2} \\ {q}_{3}\end{matrix} \} + ( - {K}^{′} ) ( \begin{matrix}1 & 0 & 0 \\ 0 & 1 & 0 \\ 0 & 0 & 1\end{matrix} ) \{ \begin{matrix}{q}_{1} \\ {q}_{2} \\ {q}_{3}\end{matrix} \} = \frac{1}{3} ( \begin{matrix}2 & - 1 & - 1 \\ - 1 & 2 & - 1 \\ - 1 & - 1 & 2\end{matrix} ) \{ \begin{matrix}{f}_{1} \\ {f}_{2} \\ {f}_{3}\end{matrix} \} \qquad ( 7 )$$

Here, it is understood that a mass and a rigid matrix are diagonalized and cross-coupled terms are not showed in the mass and the rigid matrix. However, it will be appreciated that electromagnetic force matrixes are cross-coupled to each other. In order to remove the cross-coupled terms, a PD controller is independently installed on each of axes of the active magnetic bearing. By using the PD controller, an electromagnetic force of each axis can be expressed by a following equation (8).

fⱼ=Kᵢⱼ=−KᵢK_{d}Kᵢ[Kₚqⱼ+K_{d}qⱼ], j=1,2,3 (8)

where, Kᵢ is a current stiffness, iⱼ is a control current of each axis, Kₛ and K_{A} are a sensor gain and a power amplifier gain, respectively. Further, Kₚ and K_{d} are P and D gains, respectively. By applying the equation (8) to the equation (7), the motion equation is diagonalized as a following equation (9).

$$\frac{2}{3} m [ I ] \{ q \} + {K}_{d}^{′} [ I ] \{ q \} + ( {K}_{p}^{′} - {K}^{′} ) [ I ] \{ q \} = \{ 0 \} , \\ where {K}_{d}^{′} = {K}_{i} {K}_{A} {K}_{s} {K}_{d} , {K}_{p}^{′} = {K}_{i} {K}_{A} {K}_{s} {K}_{p} \qquad ( 9 )$$

As illustrated in the equation (9), it is will be appreciated that the motion equation has the same expression in all axes and uses the P and D gains. In particular, it may be appreciated that a cross-coupled terms of the electromagnetic force are removed by using the same PD controller on each of axes and the motion equation is diagonalized.

In a method for embodying a linear model of a three-pole active magnetic bearing, therefore, an simple PD controller is independently provided on each of axes by introducing a redundant coordinates system arranged at the same interval of 120 degrees in a hybrid three-pole active magnetic bearing using a permanent magnet. Accordingly, a motion equation of an active magnetic bearing can be simply induced. Further, since a cross-coupled term is removed, an independent motion equation can be used.

In addition, in the present invention, the selection number of a gain can be reduced using symmetry, and all of three signals received by a sensor can be used.

Although embodiments in accordance with the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A hybrid three-pole active magnetic bearing comprising:
a stator including a main-magnetic pole in which three magnetic poles are arranged in a fan-shape at an interval of 120 degrees and the three magnetic poles are wound by coils respectively and a sub-magnetic pole in which three magnetic poles are arranged in a fan-shape at an interval of 120 degrees and which is provided with a permanent magnet at peripheral ends of the three magnetic poles respectively; and
a rotor enclosing a circumference of the stator,
wherein the three magnetic poles of the main-magnetic pole and the three magnetic poles of the sub-magnetic pole are alternately located at the same interval, and the sub-magnetic pole further includes a pole shoe formed as a “U” shape and provided at a peripheral end of the permanent magnet.

2. The hybrid three-pole active magnetic bearing according to claim 1, wherein a displacement sensor is provided in a “U” shaped groove of the pole shoe.

3. The hybrid three-pole active magnetic bearing according to claim 2, wherein the displacement sensor is a Hall sensor with high resolution.

4. The hybrid three-pole active magnetic bearing according to claim 1, wherein a silicon steel plate of a thickness of about 0.1 mm is stacked on the stator and the rotor.

5. A method for embodying a linear model of a hybrid three-pole active magnetic bearing, in which the linear model is embodied by introducing a redundant coordinates (q₁, q₂, q₃) arranged at the same interval of 120 degrees, and by using a PD (proportional-derivative) controller provided independently on each of three axes of the redundant coordinates system.

6. The method according to claim 5, wherein the PD controller diagonalizes an electromagnetic matrix in a motion equation of the hybrid three-pole active magnetic bearing.
